(19) United States
(12) Patent Application Publication
(10) Pub. No.: US 2010/0110823 A1
(43) Pub. Date: May 6, 2010

(54) Combined Screw Design and Heating Mechanism for Low Shear Resins

(76) Inventors: Timothy W. Womer, Edinburg, PA (US); Bruce F. Taylor, Worthington, OH (US); Walter S. Smith, New Castle, PA (US); Luke M. Miller, Farrell, PA (US)

Correspondence Address: Roth,Blair,Roberts, Strasfeld & Lodge, 100 Federal Plaza East, Suite 600, YOUNGSTOWN, OH, 44503-1893, US

(21) Appl. No.: 12/612,790

(22) Filed: Nov. 5, 2009

Related U.S. Application Data
(60) Provisional application No. 61/198,447, filed on Nov. 6, 2008.

(51) Int. Cl. B01F 7/08

(52) U.S. Cl. 366/79

(57) ABSTRACT

The apparatus and method that best results in low shear to melt shear-sensitive materials, such as polyethylene terephthalate, polyvinylchloride, acrylonitrile butadiene styrene, acrylics and/or resins with fiber fillers, without sacrificing process speed and/or cycle time, comprises the use of a barrel, screw and induction heating coil. The screw, in this case, preferably includes a low volumetric compression ratio, a relatively short feed section, an extended transition section, and a typical metering section.

This application claims priority to and the benefit of U.S. Provisional Application No. 61/198,447, filed Nov. 6, 2008, the full disclosures of which are incorporated herein by reference.

### FIELD OF THE INVENTION

This invention relates to plasticating resin using a combined screw and heating configuration in an extrusion or injection molding barrel, from which the resin extrudes or flows to form a product in a die or mold. More particularly, the invention pertains to the arrangement and structural form of a screw and barrel heating configuration that will induce low shearing during the viscous heating of the resin, that is especially suited for use in plasticating shear-sensitive materials, such as polyethylene terephthalate (“PET”), polyvinylchloride (“PVC”), acrylonitrile butadiene styrene (“ABS”), acrylics and/or resins with fiber fillers.

### BACKGROUND OF THE INVENTION

The basic plasticating device includes an elongated cylindrical barrel which is heated at various locations along its length. A screw extends longitudinally through the barrel. The screw has a core with a helical flight thereon and the flight cooperates with the cylindrical inner surface of the barrel to define a helical valley for forward passage of the resin to the plasticating device outlet port.

Since there are several different types of thermoplastic resins or polymers, and with each having different physical properties and characteristics, there are different screw configurations. In general, however, the typical plasticating screw has a plurality of sections along its extended axis with each section being designed for a particular function. Ordinarily, there is a feed section, a transition section and a metering section in series. Regarding injection screws, the feed section is typically 40% to 50% of the total screw length, and each of the transition and metering sections are conventionally 35% to 40% and 15% to 20%, respectively, of the screw length (depending on the length of the feed section). For extrusion screws, the feed section is at the lower side of the scale, on account that there is no reciprocation as with the injection screw.

The feed section extends forward from a feed opening where solid thermoplastic resins, in pellet, granular or powder form, are introduced into the plasticating unit and pushed forward by the screw along the inside of the barrel. The resin is worked and heated, conventionally using band heaters, as it passes to the transition section where the majority of melting occurs. Typically, melting is enhanced as solids subsequently become dispersed within the melt. It is important to note that the transition section has a decreased root depth of the helical valley, as compared with the feed section, to reflect the volume reduction due to melting of the feed by the elimination of air spaces between the solid particles, and to increase shear between the solid particles and the barrel's inner wall. In a conventional plasticating apparatus, most melting occurs in the transition section, and that melting takes place at or near the heat source of the barrel, i.e. the barrel's inner wall.

As previously stated, in the transition section, the melting and mixing functions are enhanced by using screw configurations which increase the compression and shearing force applied to the resin between the screw core and the barrel's inner wall. The term “compression ratio” is often used in the industry to quantify the amount of pressure imposed by the screw to compress or squeeze the plastic between the screw core and the inner wall of the barrel. To determine the compression ratio, the depth of the feed section is divided by the depth of the metering section. To assure a homogeneous melt, it is important that the transition section enhances turbulent flow, as opposed to laminar flow, via good compression and interposing barrier mixing, so that the resin comes within the heating vicinity of the barrel and/or solids are evenly dispersed throughout the melt. Otherwise, the presence of minute unmelted resin particles will appear in the finished article.

The transition section leads to the metering section. The metering section, as one of its intended functions, provides a constant flow of molten material toward the outlet port. In addition, it is important that the metering section melt any unmelted solids and mix and maintain the molten resin in a homogeneous and uniform composite until discharged through the outlet port.

Importantly, compression and shearing in the transition section, used to increase turbulence, tumbling and mixing of material, also converts mechanical energy to thermal energy, resulting in a temperature rise of the material. While higher shear rates provide better mixing, the higher temperature can cause excessive degradation for certain sensitive resins. Shear-sensitive materials include PET, PVC, ABS, acrylics and/or resins with fiber fillers.

The process variables and equipment for extruding these sensitive materials have received much attention since the low sensitivity to shear results in low output rates and low-melt strength. A wide variety of plasticating screws of different designs, for example, have been developed to address the degradation problem. Also, in order to improve throughput rate, attempts have been made to improve the onset of melting and the rate of melting by increasing the magnitude and rate of external heat input through the barrel wall to the resin. Still further, some plasticating designers choose a barrel diameter that is one size larger than would be required to produce the same output rate. However, a smaller diameter extruder has a larger heated surface area relative to its output rate. A small extruder, therefore, permits greater heat input at the transition section for melting, than would a larger extruder, but, of course, the smaller diameter barrel has higher shear, and higher shear increases degradation.

As a result, these conflicting design choices impose higher equipment and energy costs. There remains, therefore, a need to improve the output rate of shear-sensitive materials using a screw, barrel and heating apparatus design that does not unnecessarily increase equipment and production costs, and has the flexibility to process different shear-sensitive materials.

### SUMMARY OF THE INVENTION

Accordingly, it is the object of the present invention to address the aforementioned, well-known drawbacks of the conventional art.

It is another object of the present invention to provide a plasticating screw-barrel combination that avoids damage to shear-sensitive materials, such as PET, PVC, ABS, acrylics and/or resins with fiber fillers, without sacrificing process speed.

It is a further object of the present invention to permit the use of plasticating screw-barrel combinations that have relatively high compression ratios with materials that would normally require relatively low compression ratios, without increasing processing times.

It is an additional object of the present invention to avoid the need for special plasticating screw-barrel combinations, or of barrel-screw combinations of increased size when dealing with shear-sensitive materials.

It is still another object of the present invention to use plasticating screw-barrel combinations having high compression ratios without causing shear damage to certain shear-sensitive materials.

It is yet a further object of the present invention to provide a plasticating process having lower energy and equipment costs, even when dealing with shear-sensitive materials.

It is again an additional object of the present invention to provide a plasticating process with improved output rates while processing shear-sensitive materials.

It is yet another object of the present invention to provide a plasticating system in which undesirable temperature variations are avoided.

It is again a further object of the present invention to provide a plasticating process in which undesired changes to the material being plasticated are avoided.

It is yet an additional object of the present invention to provide a plasticating system which is applicable to both shear-sensitive materials and materials that are not shear-sensitive.

These and other goals and objects of the present invention are provided by an apparatus for plasticating low shear resinous materials, the apparatus having an electrically conductive barrel with a longitudinal axis along which material moves from inlet to outlet. The rotatable screw disposed within the barrel cooperates with an inner wall of the barrel. The entire apparatus is adapted for plasticating low-shear resinous material fed as a solid into the barrel through an inlet. The screw has a longitudinal axis and a main flight having a pitch arranged helically on and extending radially from the core of the screw so as to form a channel having a root depth in the axial core in reference to the inner wall of the barrel. Along the length of the screw is a feed section, a transition section and a metering section disposed sequentially downstream along the screw axis. The transition section is between 45% and 60% of the screw length, wherein the core depth of the screw is progressively reduced. Also included is an induction heater having a longitudinal length along the longitudinal axis of the barrel and a layer of thermal insulation interposed between an induction winding of the induction heater and an outer wall of the barrel. The longitudinal length of the induction heater is arranged over the feed section constituting between 20% and 30% of the screw length.

In another embodiment of the present invention, a process for plasticating low-shear solid material into a molten state under pressure is provided. In a first step, feeding a solid low-shear plastic material into the barrel is done using a rotating screw having a cylindrical inner surface along a longitudinal axis. This screw has a helical flight with the flight cooperating with the inner surface of the barrel to form a helical channel having a varied root depth in reference to the inner wall of the barrel to move the material toward an outlet port. The screw includes a feed section, a transition section and a metering section disposed sequentially downstream along the screw's longitudinal axis. The transition section is between 45% and 60% of the screw length. After feeding the material, induction heat is applied along the feed section of the barrel using an induction heater, to convert the solid plastic material to a solid-molten combination state while moving the material along the helical channel in the feed section. The induction heater has a layer of thermal insulation imposed between the induction winding of the induction heater and an outer surface of the barrel. Next, the solid-molten combination is mixed in the transition section and wherein the average root depth is reduced progressively downstream to form a substantially homogeneous molten material having substantially uniform temperature, viscosity, color and composition, and shear damage is reduced. Finally, the substantially homogeneous molten material is metered through an outlet port.

### DESCRIPTION OF THE DRAWINGS

Having generally described the nature of the invention, reference will now be made to the accompanying drawings used to illustrate and describe the preferred embodiments thereof. Further, these and other advantages will become apparent to those skilled in the art from the following detailed description of the embodiments when considered in the light of these drawings in which:

FIG. 1 illustrates a side elevational view of a conventional plasticating apparatus having a heating system comprising conventional resistive contact, band-heaters in multiple heating zones along a barrel length;

FIG. 2 illustrates a side elevational view of a conventional plasticating apparatus having an induction heating system in multiple heating zones along a barrel length;

FIG. 3 illustrates a side elevational view of a conventional plasticating apparatus having a hybrid of heating systems, including resistive contact, band-heaters and an induction heating at select heating zones;

FIG. 4A shows a conventional screw within a barrel having a unique heating arrangement according to the present invention of FIGS. 4B and 4C.

FIG. 4B shows a screw having an extended transition section according to the present invention;

FIG. 4C shows a screw having an extended transition section according to the present invention;

FIGS. 5A and 5B show yet a different screw having conventional and extended (novel) barrier transition sections, respectively;

FIG. 6 is a graphical illustration of the power savings over the barrel length using an induction heating system plotting data collected from an 85-ton, three-zone plasticating apparatus and a 1000-ton, four-zone plasticating apparatus; and

FIG. 7 is a sectional view of a barrel being heated by a conventional resistive contact, heater wrapped by an insulation sheet to reduce heat loss.

### DESCRIPTION OF THE PREFERRED EMBODIMENT

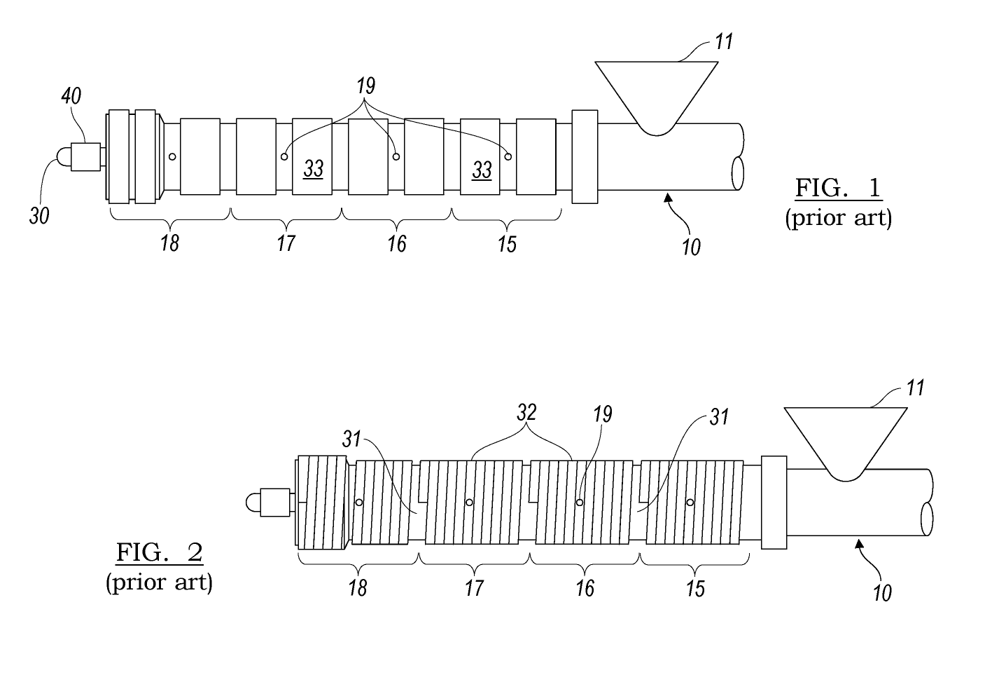

Referring to FIGS. 1-4A, a plasticating device is shown with a cylindrical barrel 10 having a cylindrical inner lining surface or wall 12. The barrel 10 has an inlet port 11 for the admission of one or more thermoplastic resinous materials and any required additives or agents. The barrel 10 is also provided with an outlet or discharge port 30 for the discharge of molten material. Within the barrel 10 is a screw “S” which is rotated by conventional means not shown. The screw “S” includes a helical flight 20 winding around a core 22, typically in a right hand threaded direction. The flight 20 includes flight land 24 which moves in close cooperative proximity with the inner surface 12 of the barrel 10. The helical flight 20 disposed within and cooperating with an inner surface 12 of a heated barrel 10 forms a forwardly flowing channel. The axial distance between comparable points on adjacent flights or channels corresponds with the pitch and helix angle of the flight or channel.

The screw “S” includes a plurality of sections along its axial extent with each section being suited to attain a particular function. Ordinarily, there is a feed section “A”, a transition section “B” and a pumping or metering section “C” (sometimes also referred to as “mixing section”), in series. The inlet port 11 is the rearmost part of the upstream feed section “A”, and the discharge port 30 is the endmost part of the downstream metering section “C”.

The flight 20 defines a helical valley 21 bounded by flight 20, inner surface 12 of the barrel 10 and the surface of the core 22. The surface of the valley 21 on the core 22 is the root of the valley. The screw “S” includes a relatively deep root depth “x” in the feed section “A” for the admission, heating and working of solid resin; a gradually reduced depth “y” in the transition section “B” to adapt to the reduced volume of resin due to the elimination of air spaces between the solid particles; and a relatively shallow root depth “z” in the metering section “C” wherein the resin is optimally in a molten state. The depth compression ratio is defined as the feed depth divided by the metering depth. The higher the compression ratio, typically results in higher shear.

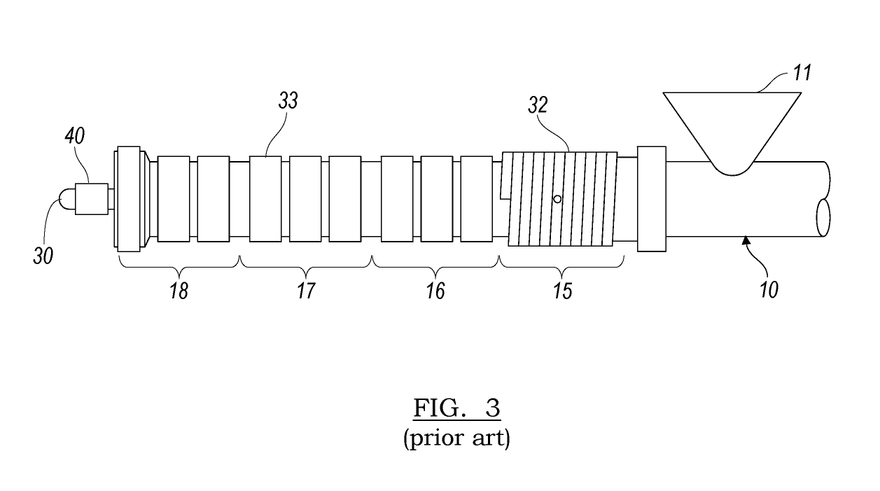

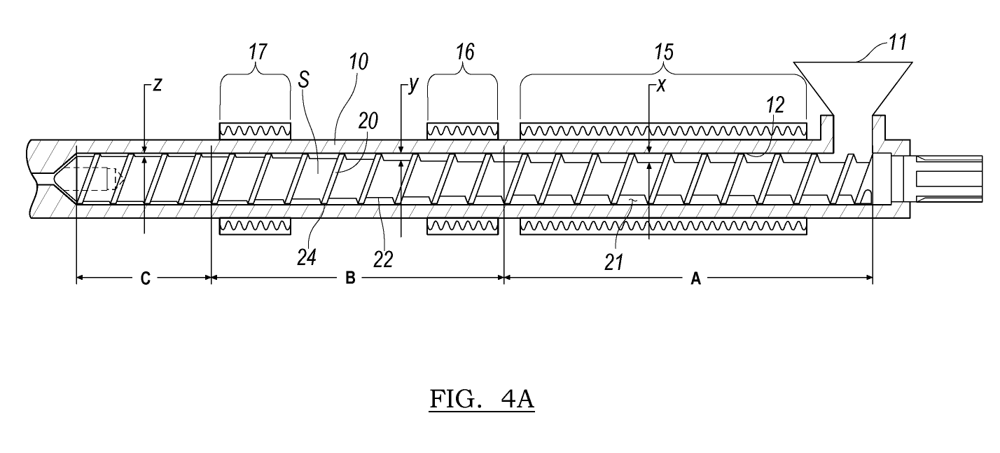

Referring again to FIGS. 1-4A, solid resin feed material, typically in the form of pellets, regrind or powder, enters the feed section “A” of the barrel 10 through the inlet port 11 and then is conveyed, melted and mixed by the feed screw that rotates within the barrel. The screw “S” has a discharge cone or valve (not shown) employed at the end of the metering section “C”. The resulting homogeneous molten material is pumped through a nozzle or die at the discharge port 30 of the barrel. To help melt the plastic, the barrel 10 is heated, conventionally with external resistive contact heaters 33 commonly referred to as band-heaters, best seen in FIG. 1, and more recently by induction heaters, best seen in FIG. 2. Electrical circuitry for both band-heaters and induction heaters (as depicted in FIG. 3) is usually arranged so that the barrel 10 can be heated in multiple controllable zones 15, 16, 17, 18 along its length (typically three to nine zones), with a thermocouple 19 located in the barrel wall per zone to provide temperature measurement feedback. The nozzle or die at the discharge port 30 is usually heated and temperature controlled separately using one or more dedicated resistance heaters 40. AC induction has also been used to heat injection molding and extrusion barrels, by inducing eddy currents within the barrel wall to produce direct resistive heating of the barrel 10.

The feed screw “S” is typically used not only to convey the solid resin along the feed section “A” of the screw, but also to melt the resin by using mechanical energy to generate viscous heating in the transition section “B” of the screw, prior to the resin being pumped and mixed in the final portion, i.e. metering section “C”, of the screw. This mechanical energy also shears the resin which typically induces unwanted material properties. Adding viscous heat to the process by the action of the screw “S” is a difficult phenomenon to control, and it is well known by those skilled in the art that it is easier to accurately and consistently control the temperature of the resin by using the barrel heating system (i.e. band-heaters or induction), than to do so by trying to regulate the amount of energy generated by the action of the screw, via compression and shear. This is important because larger variations in the temperature of a resin during processing produce larger variations in unwanted material properties.

For example, in the case of processing PET for the use of beverage bottle pre-forms, higher shear produces higher amounts of undesirable acetaldehyde (CH₃CHO and also referred to as “AA”) in the final product. Furthermore, increasing the variability of the PET's temperature during processing also increases the variability of the AA in the final product. To minimize the amount of AA in any sample population of PET product, it is desirable, therefore, to minimize the amount of viscous heating and shear imparted by the screw.

The preferred embodiment of this invention, therefore, includes various aspects of combined induction and band heating to a barrel (as depicted in FIG. 3), resulting in a more economical and efficient way to quickly add heat to the resin in the feed section “A” of the screw, yet maintain and supplement smaller amounts of heat in the transition section “B” and metering section “C”. This hybrid heating configuration is optimal for the following reasons.

The point of heat origination using induction heating in the feed section “A” is closer to barrel axis than with band-heaters, so the radial conduction distance to the intended target-point of use (the inner surface 12 of the barrel 10) is shorter. As a result, there is less time for heat to conduct axially and, therefore, to spread out along the length of the barrel. The heat application is therefore more concentrated in the intended lengthwise targeted region in the feed section “A”.

Induction heating is not inherently limited by any maximum operating temperature limitation or heat generation density. Subject to the power output limit of the induction power supply, this typically enables much higher heat addition per unit of barrel length.

Induction coil windings can be concentrated to apply the heat where it is most needed.

Due to its minimal thermal inertia and instantaneous response, induction heating can be more easily synchronized with the cyclical heat demand of injection molding machines. This allows the addition of heat to be maximized during that point in the cycle when the cold resin enters the feed section “A” of the screw. More total heat addition over time can then be applied in the feed section “A” of the screw without causing the temperature of the resin at any point in time to exceed its desired maximum. Adding more total heat over time in the feed section “A” thereby allows less viscous heating to be needed downstream in the transition “B” and metering sections “C”. As a result, band heaters 33, preferably wrapped in insulation sheets 34, in the transition and metering sections, “B” and “C”, respectively, are more than adequate, thereby reducing the total cost of the heating system.

In accordance with Lenz's law, the magnetic field generated by a helical induction coil must apply an axial force on the enclosed cylindrical load (i.e. the barrel 10). Accordingly, AC induction must apply a cyclical axial force on the barrel 10. This cyclical force will in turn produce an alternating frictional shear force between the internal wall of the barrel and the resin in contact with it. With a high-frequency induction barrel heating system (i.e. 10-40 kHz), the resulting high-frequency frictional interaction between the barrel 10 and resin will heat and help melt the resin in the same manner that high-frequency ultrasonic forces can be used to heat and melt resins.

The existence of this additional source of resin-heating energy means that less viscous heating and shearing needs to be produced and imparted by the mechanical action of the screw. Further, the high frequency vibrations from the alternating electric field apparently creates sufficient vibration in the barrel wall 12 to inhibit sticking of the material to be melted, thereby decreasing destructive shear within the barrel.

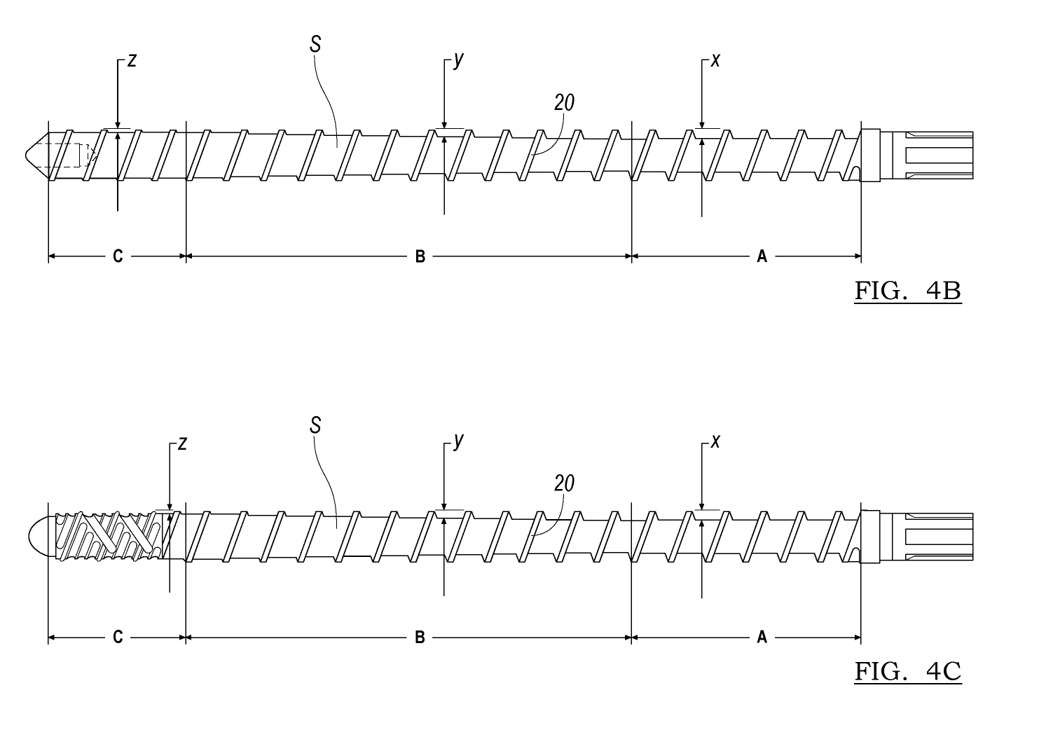

Referring now to FIGS. 4A and 4B, both screw designs show a total of twenty-two turns of the main helical flight 20 over the screw length, i.e. from feed section through metering section. In comparison, FIG. 4A shows a screw “S” having a feed section with ten turns, transition section with eight turns, and metering section with four turns. FIG. 4B, on the other hand, shows the feed section with six turns, the transition section “B” with twelve and the metering section with four turns. Notably, the compression ratio (i.e. the depth in feed section “x” in comparison to the depth in the metering section “z”) does not change, yet the shear applied to the resin material in the transition section “B”, due to the change in the root depth “y”, is reduced by approximately 33%. In other words, by increasing the length of the transition section “B” from eight to twelve turns, on account of the reduced number of turns in the feed section, i.e. ten to six turns, the amount of shear is reduced without changing the compression ratio or modifying the length of the screw “S” and barrel 10. The design change in the screw “S” shown in FIG. 4B is possible due to the enhanced heating in the feed section “A” using induction heaters 32. Various screw designs may be added in the metering section “C” to further enhance mixing and homogenation of the molten material, such as that shown in FIG. 4C, without impacting the benefit of the reduced feed section “A” and longer transition section “B”.

Because of the advanced heating in the feed section “A” and the lengthened transition section “B”, screw-barrel arrangements with higher compression ratios can be used without introducing destructive shear to certain materials. This allows single screw-barrel combinations to be used for a wider variety of different types of materials than with conventional arrangements. A single arrangement incorporated in the present invention would be able to deal with both shear-sensitive materials and those that normally prove much higher compression ratios than shear-sensitive materials.

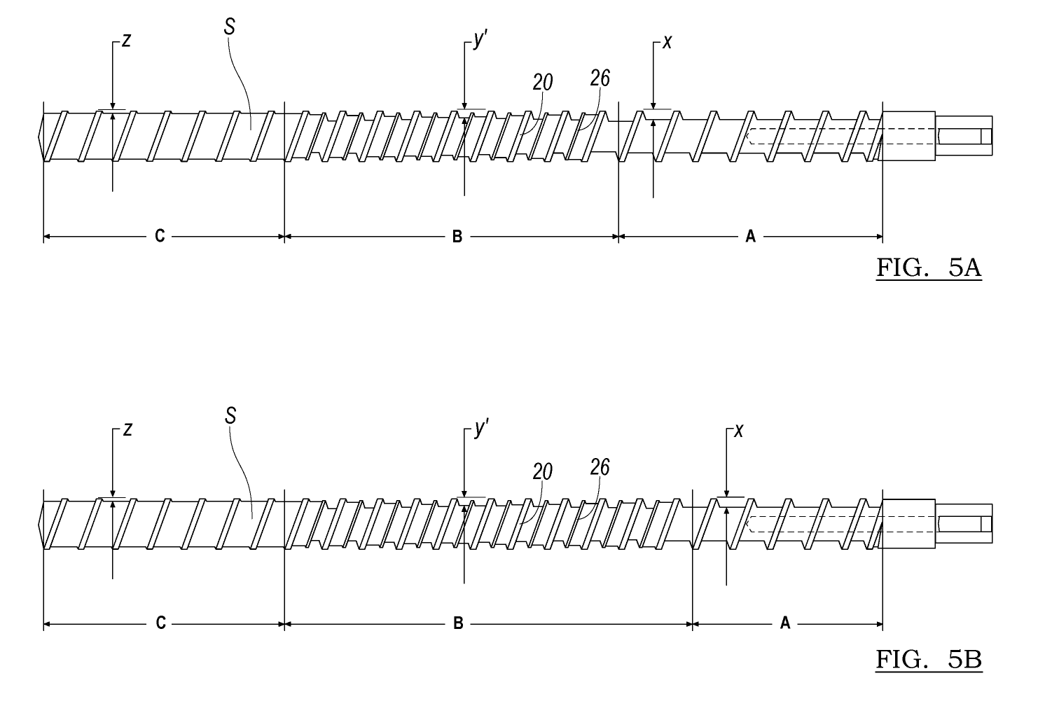

FIGS. 5A and 5B illustrate a modification of screw sections according to the present invention. As shown in FIGS. 4B and 4C, solid resin enters the barrel at the feed section “A” where it is heated and conveyed forward. The feed section “A” is followed by a transition section “B” having barrier flight 26 for separating resin solids from the resin melt, to form a first channel containing solid resin and a second channel containing melted resin. The solids channel is relatively deep at the beginning of the transition section and gradually becomes shallower along the length of the transition section as the volume of solids decreases. The melt channel gradually becomes deeper along the length of the transition section “B” to accommodate the increasing volume of the melt. The average depth “y′” gradually decreases along the length of the screw. The typical length of the transition section “B”, as shown in FIG. 5A, is about eight to nine turns of the main helical flight 20. However, using induction heaters 32 in the feed section “A”, the transition section “B” having the barrier flight to separate the solid channel and melt channel, can be extended to eleven to twelve turns, thereby reducing the shear by approximately 25% to 50%.

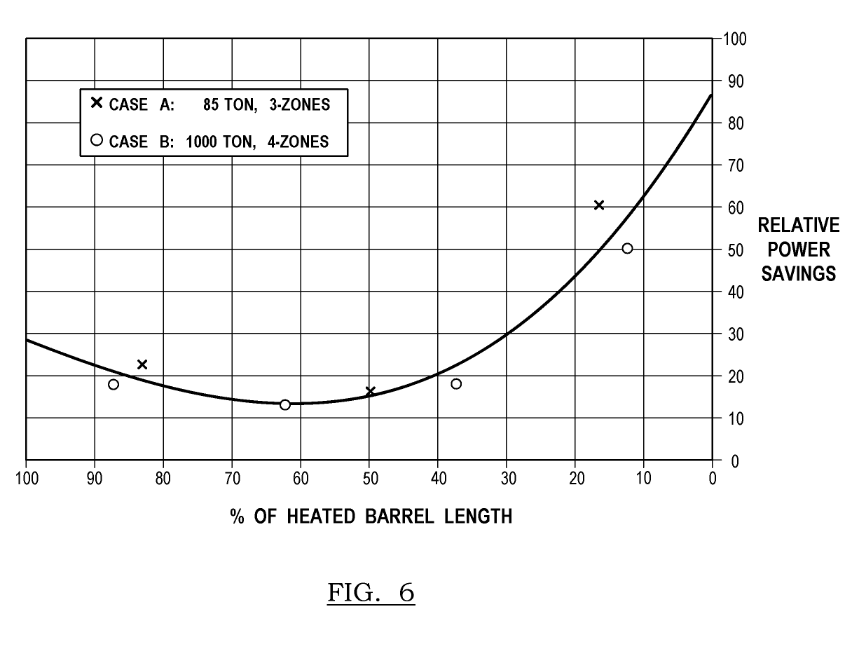

FIG. 6 is a graph depicting relative power savings for heat added along the length of a plasticating barrel. It is clear from this graph that the vast majority of power savings, and thus higher efficiencies result in external heat being added in the first 30% of the barrel length. In practical terms, this means that the external heat is added at the feed section. For the reasons previously discussed, the heat is best transferred to the barrel (and the material within the barrel) using induction heating applied along the first 30% of the barrel length. Based upon tests made using the present invention, between 80% and 95% of all external heat to be added to the barrel should be added along the first 30% of the barrel length for maximum efficiency. This operating parameter is one of the requirements of the present invention and leads to the benefits discussed throughout this application.

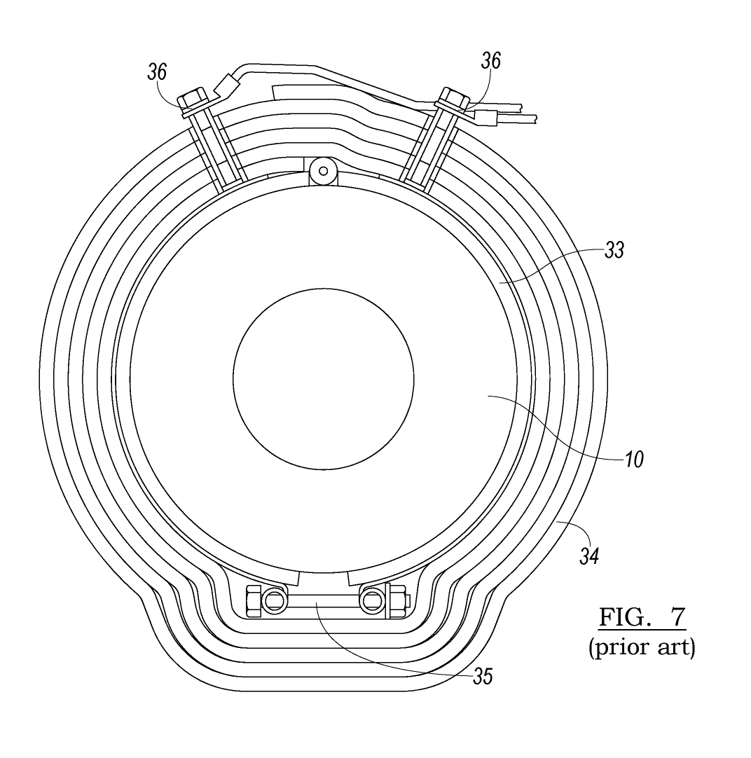

FIG. 7 depicts a barrel 10 enclosed by a resistive heater 33. The resistive heater is constituted by conventional structures. An additional insulating layer 34 is placed around heater 33 for greater efficiency. Part or all of the resistive heater 33 assembly can be held to barrel 10 using a clamping assembly 35. Any number of different configurations can be used to hold the insulator 34 and resistive heater 33 to barrel 10. Power is provided to the resistive heater 33 via electrical contacts 36. Ceramic or other types of heaters can be substituted for resistive heaters 33.

The induction heaters 32 of the present invention are confined to the feed section “A”. The ratio of screw turns in the feed section to the turns in other sections is included in FIGS. 4A-5B. For example, FIG. 4A is a conventional screw using a conventional proportion of turns. In particular, the feed section “A” has ten turns. The transition section has eight turns and the metering section has four turns. This is a total of twenty-two turns with 45% allocated to the feed section “A”, 36% allocated to the transition section “B” and 18% allocated to the metering section “C”. In contrast, FIGS. 4B and 4C employ the proportions of the present invention whereby the feed section “A” (with the induction heating) is six turns or 27% of the screw (twenty-two turns). The transition section “B” is twelve turns or 55% of the total screw length, while the metering section “C” is four turns, or approximately 18% of the entire length. It is the extended transition length which provides the beneficial shear control of the present invention.

The present invention, relying upon induction heaters over the feed section “A”, permit a shortened feed section while still providing the necessary external heat to prepare the mixture for easy viscous melting. For example, FIG. 5A has a twenty-three turn screw with seven turns in the feed section “A” constituting 30% of the length. The other 70% is constituted by the transition section “B” and the metering section “C” combined. In FIG. 5B, the arrangement in accordance with the present invention, permits a shortening of the feed section “A” to five turns of the screw, or 20% of the screw length. The metering section “C” remains the same, while the transition section “B” constitutes 50% of the screw length.

The present invention provides an improved plasticating apparatus having a heated barrel with an axial length wherein solid material is introduced through an inlet port 11 and exits as molten material through an outlet port 30 of the barrel 10. The heated barrel has an inner-wall and a screw rotatably supported therein. The screw comprises at least one helical flight extending along its length to define a helical channel with the inner-wall. Also, said screw typically has at least a feed section “A” cooperating with said inlet port 11, an intermediate transition section “B”, and a metering section “C” cooperating with said outlet port 30. The improvement herein comprises an arrangement and structural form of a screw and barrel heating configuration that will induce low shearing and enhanced heating of the resin, which is especially suited for use in plasticating shear-sensitive materials, such as PET, PVC, ABS, acrylics and/or resins with fiber fillers, without sacrificing process speed and/or cycle time.

In accordance therewith, the melting and mixing functions of the transition section “B” of the plasticating apparatus are enhanced for shear-sensitive materials, reducing resin degradation and increases uniformity of the temperature, viscosity, color and composition of the molten material ultimately discharged downstream. More specifically, an embodiment of the present invention combines an energy efficient, responsive induction barrel heating system 32 over the feed section “A” of the screw, in combination with an elongated transition section “B”, preferably having a low volumetric compression ratio (i.e., 1.2 to 1.8), and therefore, low-shearing features (i.e. inducing minimal viscous heating and shearing of the resin). By using an induction heating system 32 in the feed section “A”, the length of the feed section can be reduced and the transition section “B” can be extended to reduce the slope, i.e. rate of change of the depth of the helical valley, such that relatively low-shear and temperature variations result in the resin, minimizing undesirable resin properties such as high AA levels, degradation and/or broken fibers. In the preferred application, the shear-sensitive resin material is selected from the group comprising PET, PVC, ABS, acrylics and resins with fiber fillers.

The benefits of the present invention are achieved by the selective application of induction heaters, or even ceramic heaters, at a particular part of the screw (feed section “A”) while adjusting the lengths of the other parts of the screw to achieve the superior shear control.

It will thus be seen that a new and useful plasticating apparatus and method combining induction heating with modified screw design have been illustrated and described. It will be apparent to those skilled in the art that various changes or modifications may be made to the invention without departing from the spirit thereof. In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. An apparatus for plasticizing low-shear resinous material, comprising:
an electrically conductive barrel having a longitudinal axis, along which material moves axially from an inlet to an outlet;
a rotatable screw disposed within and cooperating with an inner wall of said barrel, said screw adapted for plasticating low-shear resinous material fed into said barrel through said inlet as a solid, the screw having a longitudinal axis and a main flight having a pitch arranged helically on, and extending radially from a core of the screw forming a channel having a root depth in the axial core in reference to the inner wall of said barrel, the screw including a length having a feed section, a transition section and a metering section disposed sequentially downstream along said screw axis, the transition section being between about 45% to 60% of the screw length, wherein the core depth is progressively reduced; and,
an induction heater having a longitudinal length along the longitudinal axis of the barrel and a layer of thermal insulation interposed between an induction winding of the induction heater and an outer wall of the barrel, the longitudinal length of the induction heater arranged over the feed section between 20% and 40% of the screw length.

2. The plasticating apparatus of claim 1, wherein the feed section is between 20% and 30% of the screw length.

3. The plasticating apparatus of claim 1, wherein the induction heater operates in a range of 10 to 40 kHz, and the shear sensitive material is selected from the group comprising PET, PVC, ABS, acrylic and resin with fiber filler.

4. The plasticating apparatus of claim 3, wherein the feed section is between 20% and 25% of said barrel length.

5. The plasticating apparatus of claim 1, wherein 80% to 95% of external heat added to the low-shear resinous material is provided to said feed section by the induction heater.

6. The plasticating apparatus of claim 4, wherein the channel of the transition section includes a barrier flight.

7. The plasticating apparatus of claim 3, further comprising a plurality of heating bands with insulated covers over the outer wall of the barrel and along the length of the longitudinal axis of the barrel arranged over the transition and metering sections of the screw.

8. The plasticating apparatus of claim 3, wherein said screw has a volumetric compression ratio of between 1.2 and 3.

9. The plasticating apparatus of claim 3, wherein said screw has a volumetric compression ratio of between 1.2 and 1.8.

10. A process of plasticating low-shear solid plastic material into a molten state under pressure, the process comprising the steps of:
(a) feeding solid low-shear plastic material with a rotating screw in a barrel having a cylindrical inner surface along a longitudinal axis, said screw having a helical flight with said flight cooperating with said inner surface to form a helical channel having a varied root depth in reference to the inner wall of said barrel to move said material toward an outlet port, the screw including a feed section, a transition section and a metering section disposed sequentially downstream along said screw longitudinal axis, the transition section is between about 45% to 60% of the screw length;
(b) applying induction heat along the feed section of said barrel using an induction heater to convert the solid plastic material to a solid-molten combination state while moving the material along said helical channel in the feed section, the induction heater having a length, and a layer of thermal insulation interposed between an induction winding of the induction heater and an outer surface of the barrel;
(c) mixing said solid-molten combination in the transition section arranged to reduce shear damage to said solid-molten combination, wherein the average root depth is reduced progressively downstream to form a substantially homogeneous molten material having substantially uniform temperature, viscosity, color and composition; and,
(d) metering said substantially homogeneous molten material through said outlet port.

11. The plasticating process of claim 10, further comprising the step of:
(e) applying resistant heat along the transition and metering sections using a plurality of heating bands in heating zones over the outer wall and along the length of the longitudinal axis of the barrel.

12. The plasticating process of claim 10, wherein the induction heater operates in a range of 10 to 40 kHz, and the low-shear plastic material is selected from the group comprising PET, PVC, ABS, acrylic and resin with fiber filler.

13. The plasticating process of claim 11, wherein said screw has a compression ratio of between 1.2 and 3.

14. The plasticating process of claim 12, wherein said screw has a compression ratio of between 1.2 and 1.8.

15. The plasticating process of claim 12, wherein 80% to 95% of the external heat added to the low-shear resinous material is provided in said feed section by the induction heater.

16. The plasticating process of claim 15, wherein the feed section is between 20% and 30% of the screw length.

17. The plasticating process of claim 16, wherein the metering section is between 20% and 30% of the screw length.

18. The plasticating process of claim 16, wherein the channel in the transition section includes a barrier flight.
